(19) United States
(12) Patent Application Publication
(10) Pub. No.: US 2025/0350067 A1
(43) Pub. Date: Nov. 13, 2025

(54) CONNECTOR

(71) Applicant: SUMITOMO WIRING SYSTEMS, LTD., Mie (JP)

(72) Inventor: Kazuki KOIDE, Mie (JP)

(21) Appl. No.: 18/862,556

(22) PCT Filed: Apr. 21, 2023
(86) PCT No.: PCT/JP2023/016011

§ 371 Date: Nov. 4, 2024

(30) Foreign Application Priority Data
May 12, 2022 (JP) 2022-078605

(51) Int. Cl. H01R 13/629

(52) U.S. Cl. CPC H01R 13/62955; H01R 13/62938

(57) ABSTRACT

A lever (70) has a pair of side portions (72) facing each other in a width direction, and a connecting portion (71) connecting the pair of side portions (72). A cover (50) includes a pair of cover side surface portions (51) located on an inner side of the pair of side portions (72) in the width direction. A housing (11) includes a pair of housing side surface portions (22) arranged side by side with the pair of cover side surface portions (51), at positions opposite the pair of cover side surface portions (51) with an outer periphery of a drawing-out surface (27) as a boundary. The lever (70) is apart from the housing side surface portions (22) in an arrangement direction of the cover side surface portions (51) and the housing side surface portions (22).

### TECHNICAL FIELD

The present disclosure relates to a connector.

### BACKGROUND

The connector in Patent Document 1 includes a housing (housing body), a cover (electric wire cover) attached to the housing so as to cover the rear surface of the housing, and a lever rotatably supported by the housing. Sliders are attached to the housing. The sliders slide relative to the housing in response to the rotation of the lever, to fit or detach the housing and a mating housing (second housing). The housing contains a plurality of terminal fittings (first terminal fittings). Each terminal fitting is connected to a terminal portion of an electric wire. The electric wire cover determines the routing direction of each electric wire drawn out from the rear surface of the housing.

The lever has a pair of side portions (arm portions) in the width direction and a connecting portion connecting the side portions. The lever is disposed across the cover. Part of the side portions is located on the outside of the side surface portions of the cover, and the other part of the side portions is located on the outside of the side surface portions of the housing. This type of connector is also disclosed in Patent Documents 2 to 4.

### PRIOR ART DOCUMENT

### Patent Document

Patent Document 1: JP 2018-195400 A
Patent Document 2: JP 2007-242251 A
Patent Document 3: JP 2008-218302 A
Patent Document 4: JP 2011-204494 A

### SUMMARY OF THE INVENTION

### Problems to be Solved

The connectors in Patent Documents 1 to 4 have a structure in which the width dimension of the lever corresponds to the width dimension of the cover and the side portions of the lever are aligned with the side surface portions of the cover so that the cover will suppress deformation when the lever rotates.

In the case where the number of terminal fittings contained in the housing is smaller than usual, the number of electric wires arranged inside the cover is smaller. In such a case, the width dimension of the cover is required to be reduced in order to reduce the size of the connector. However, even when an attempt is made to reduce the width dimension of the cover and further to reduce the width dimension of the lever, the width dimension of the lever cannot be changed in the part that overlaps with the housing (i.e. the other part of the side portions) because the width dimension of the housing is unchanged. This may make it difficult to design the lever and hinder size reduction of the connector.

In view of this, the present disclosure has an object of providing a connector that can be reduced in size.

### Means to Solve the Problem

A connector according to the present disclosure includes: a housing including a drawing-out surface for drawing out an electric wire; a cover attached to the housing to cover the drawing-out surface; and a lever rotatably supported by the housing, wherein the lever includes a pair of side portions facing each other in a width direction, and a connecting portion connecting the pair of side portions, the cover incudes a pair of cover side surface portions located on an inner side of the pair of side portions in the width direction, the housing includes a pair of housing side surface portions arranged side by side with the pair of cover side surface portions, at positions opposite the pair of cover side surface portions with an outer periphery of the drawing-out surface as a boundary, and the lever is apart from the pair of housing side surface portions in an arrangement direction in which the pair of cover side surface portions and the pair of housing side surface portions are arranged side by side.

### Effect of the Invention

According to the present disclosure, it is possible to provide a connector that can be reduced in size.

### BRIEF DESCRIPTION OF THE DRAWINGS

FIG. 1 is an exploded perspective view of a connector in Embodiment 1 of the present disclosure.

FIG. 2 is a plan view of the connector in which a lever is at a start position relative to a housing.

FIG. 3 is a plan view of the connector in which the lever is at a fitting position relative to the housing.

FIG. 4 is a bottom view of the connector in which the lever is at the fitting position relative to the housing.

FIG. 5 is a sectional view of part of the connector in which the lever is at the fitting position relative to the housing and that is fitted with a mating housing.

FIG. 6 is a perspective view of an outer housing.

FIG. 7 is a perspective view of a cover.

FIG. 8 is a perspective view of the lever.

FIG. 9 is a view corresponding to FIG. 4 of a connector with specifications in which the width dimensions of a lever and a cover are small.

### DETAILED DESCRIPTION TO EXECUTE THE INVENTION

### Description of Embodiments of the Present Disclosure

First, embodiments of the present disclosure will be listed and described.

(1) A connector according to the present disclosure is the following: a connector includes: a housing having a drawing-out surface for drawing out an electric wire; a cover attached to the housing to cover the drawing-out surface; and a lever rotatably supported by the housing, wherein the lever includes a pair of side portions facing each other in a width direction, and a connecting portion connecting the pair of side portions, the cover includes a pair of cover side surface portions located on an inner side of the pair of side portions in the width direction, the housing includes a pair of housing side surface portions arranged side by side with the pair of cover side surface portions, at positions opposite to the pair of cover side surface portions with an outer periphery of the drawing-out surface as a boundary, and the lever is apart from the pair of housing side surface portions in an arrangement direction in which the pair of cover side surface portions and the pair of housing side surface portions are arranged side by side.

With this structure, the width dimension of the lever can be set without being restricted by the housing side surface portions. Therefore, in the case where the number of electric wires drawn out from the drawing-out surface of the housing decreases, the width dimension of the cover can be reduced and further the width dimension of the lever can be reduced depending on the reduction in the width dimension of the cover without changing the width dimension of the housing. The connector can thus be reduced in size.

(2) Preferably, the lever includes a rotation shaft in a base end portion of each of the side portions, and the housing includes a bearing portion configured to receive the rotation shaft, at a position shifted to one side in a lateral direction relative to the housing side surface portions, the lateral direction intersecting the arrangement direction.

With this structure, the lever length from the rotation shafts to the connecting portion can be made long, so that the lever can be rotated with a small force.

(3) Preferably, the base end portion has a shape extending in the arrangement direction across the cover and the housing, and each of the side portions has a main portion extending from a position in the base end portion closer to the cover to another side in the lateral direction.

With this structure, the side portions of the lever can have a simple shape.

(4) Preferably, the pair of cover side surface portions each include a wide portion located on a side closer to the housing in the arrangement direction, a narrow portion narrower than the wide portion and located on a side farther from the housing in the arrangement direction, and a step portion located between the wide portion and the narrow portion, and the main portion is located along the narrow portion.

With this structure, the width dimension of the lever can be reduced by the narrowness of the narrow portion, so that the connector can be reduced in size.

(5) Preferably, when the housing and a mating housing are in a fitting state, the main portion faces the step portion to be able to be in contact with the step portion.

With this structure, when the housing and the mating housing reach a fitting state, the main portion comes into contact with the step portion, with it being possible to stop the rotation operation of the lever. Moreover, as a result of the main portion coming into contact with the step portion, the cover can be prevented from deforming on the step portion side.

(6) Preferably, the step portion includes a recess that is recessed in the arrangement direction, and the main portion includes a projection that is fitted into the recess in the fitting state.

With this structure, when the housing and the mating housing are in a fitting state, the lever can be restricted from being misaligned relative to the housing.

### Details of Embodiments of the Present Disclosure

Specific examples according to the present disclosure will be described below, with reference to the drawings. The present disclosure is not limited to these examples, but is defined by the claims and intended to include all modifications within the meaning and scope equivalent to the claims.

### Embodiment 1

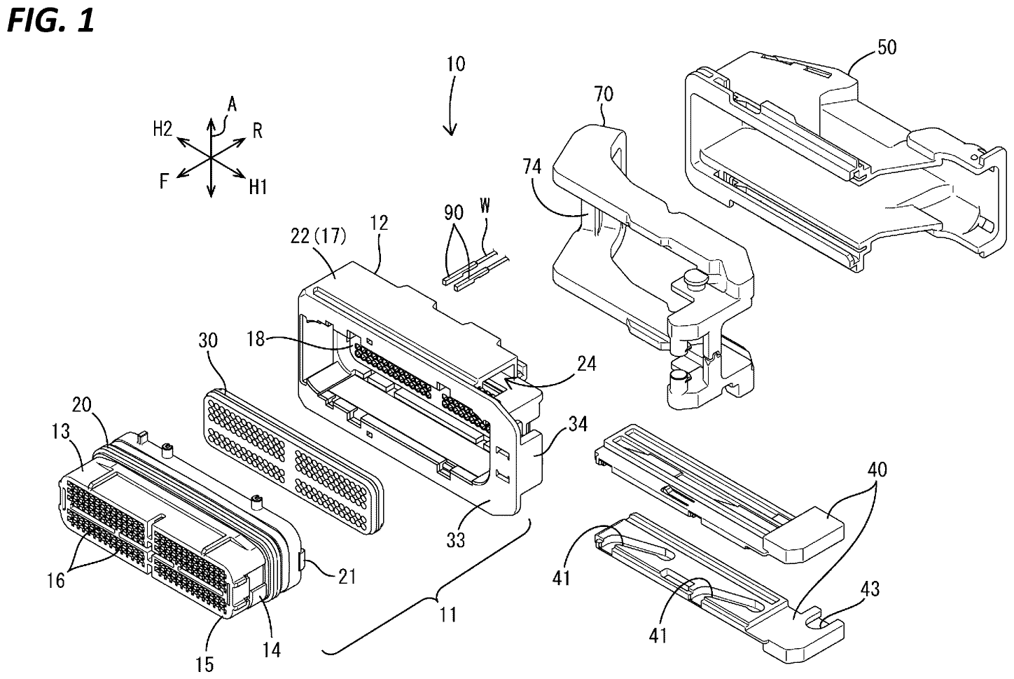

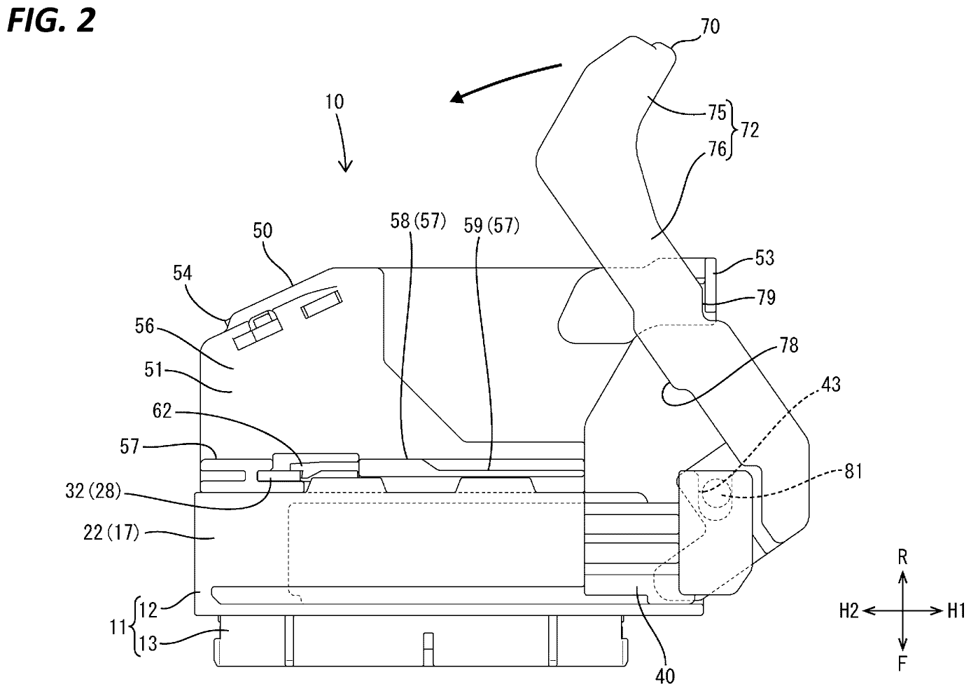

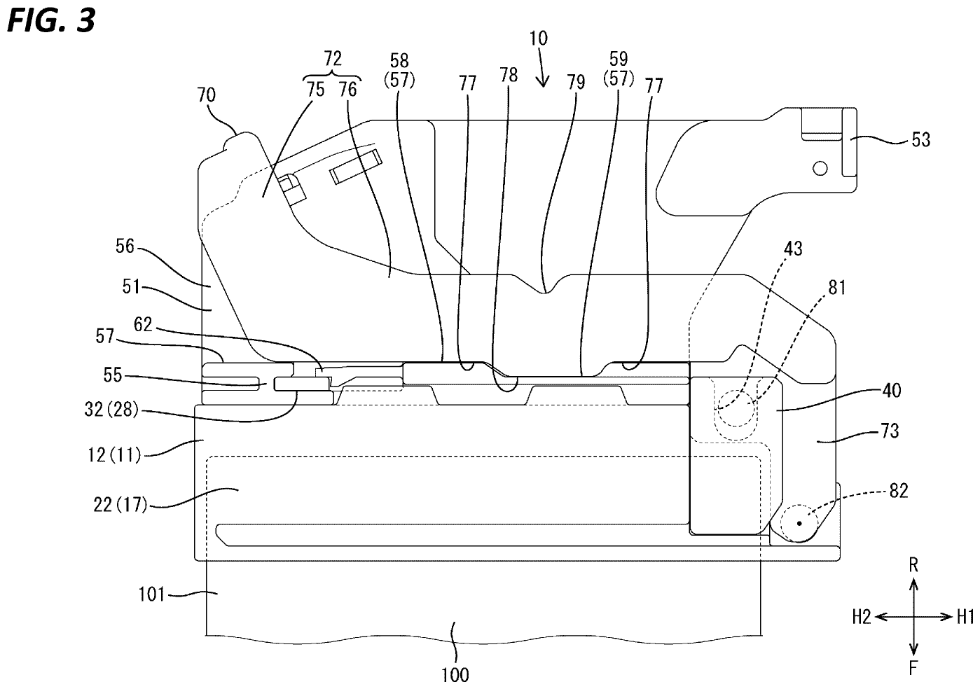

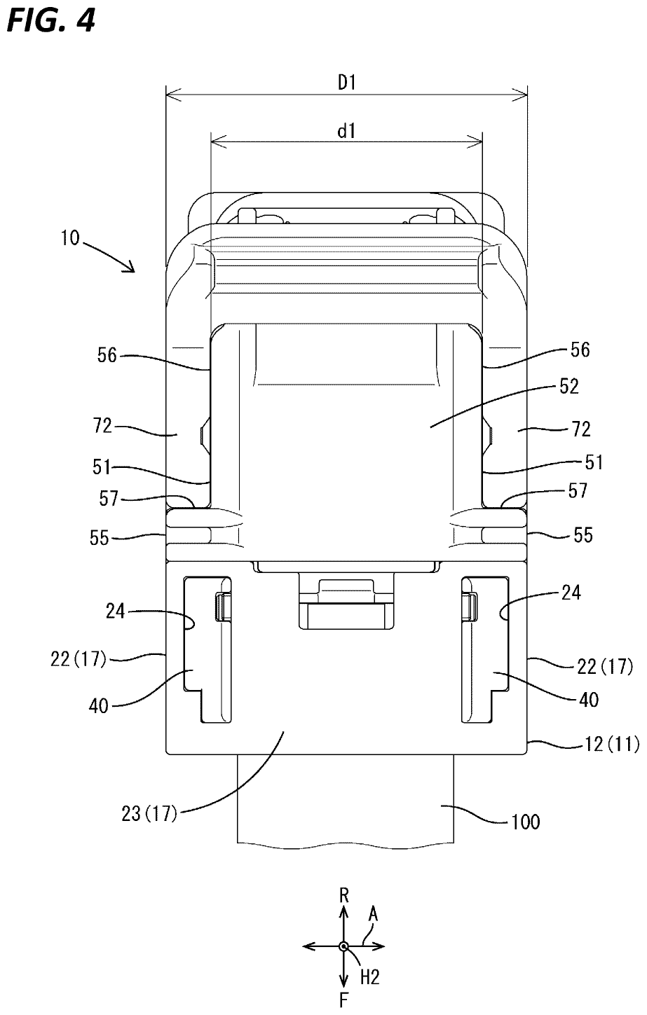

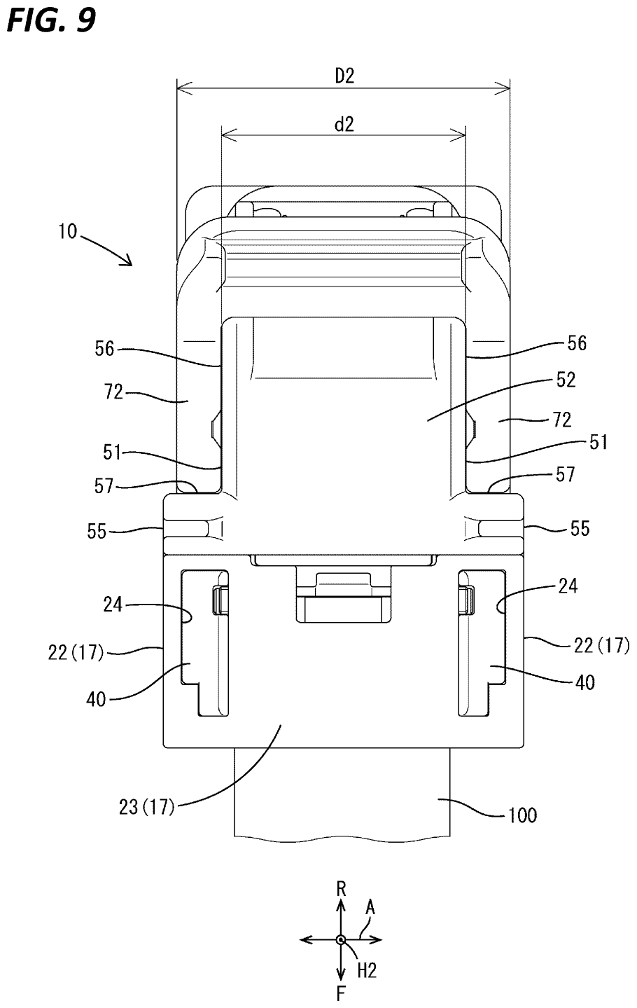

A connector 10 according to Embodiment 1 of the present disclosure includes a housing 11, sliders 40, a cover 50, a lever 70, and terminal fittings 90, as shown in FIGS. 1 and 2. The housing 11 can be fitted to a mating housing 100, as shown in FIG. 3. In the following description, the side on which the housing 11 is fitted to the mating housing 100 is referred to as the front side in the front-rear direction. The lower side in FIGS. 2 and 3 is the front side. The width direction is the thickness direction of the paper of FIGS. 2 and 3, and corresponds to the left-right direction in FIG. 4. The lateral direction is a direction intersecting the front-rear direction and the width direction, and corresponds to the left-right direction in FIGS. 2 and 3. One side in the lateral direction (i.e. one lateral side) corresponds to the right side in FIGS. 2 and 3, and the other side in the lateral direction (the other lateral side) corresponds to the left side in FIGS. 2 and 3. In FIGS. 1 to 4 and 9, the front side is indicated by symbol F, the rear side by symbol R, the one lateral side by symbol H1 (not shown in FIGS. 4 and 9), and the other lateral side by symbol H2. In FIGS. 1, 4, and 9, the width direction is indicated by symbol A. In the following description, parts that are less relevant to the presently disclosed techniques are omitted in the drawings.

### Housing, Terminal Fittings, etc.

The housing 11 is made of synthetic resin, and includes an outer housing 12, an inner housing 13, a retainer 14, and a front mask 15 as shown in FIG. 1.

The inner housing 13 is shaped as a rectangular block that is long in the lateral direction. A rubber seal ring 20 is attached to the outer periphery of the inner housing 13. When the housing 11 and the mating housing 100 are in a fitting state, the seal ring 20 is sandwiched between the inner housing 13 and the mating housing 100 to liquid-tightly seal the gap between the housing 11 and the mating housing 100. A batch rubber stopper 30 made of rubber is attached to the rear end of the inner housing 13. The batch rubber stopper 30 is sandwiched between the below-described rear wall 18 of the outer housing 12 and the inner housing 13. The inner housing 13 has a plurality of cavities 16 extending in the front-rear direction.

The terminal fittings 90 are inserted from the rear into the cavities 16 of the inner housing 13 and contained therein. The terminal fittings 90 are made of conductive metal and are connected by crimping to the terminal portions of electric wires W. The electric wires W pass through the batch rubber stopper 30 liquid-tightly and are drawn out rearward from the below-described drawing-out surface 27 of the outer housing 12.

The retainer 14 is attached to the inner housing 13 and locks the terminal fittings 90. The retainer 14 restricts the terminal fittings 90 from coming out of the inner housing 13. The front mask 15 is attached to the inner housing 13 so as to cover the front surface of the inner housing 13. Each cavity 16 of the inner housing 13 also passes through the front mask 15 coaxially.

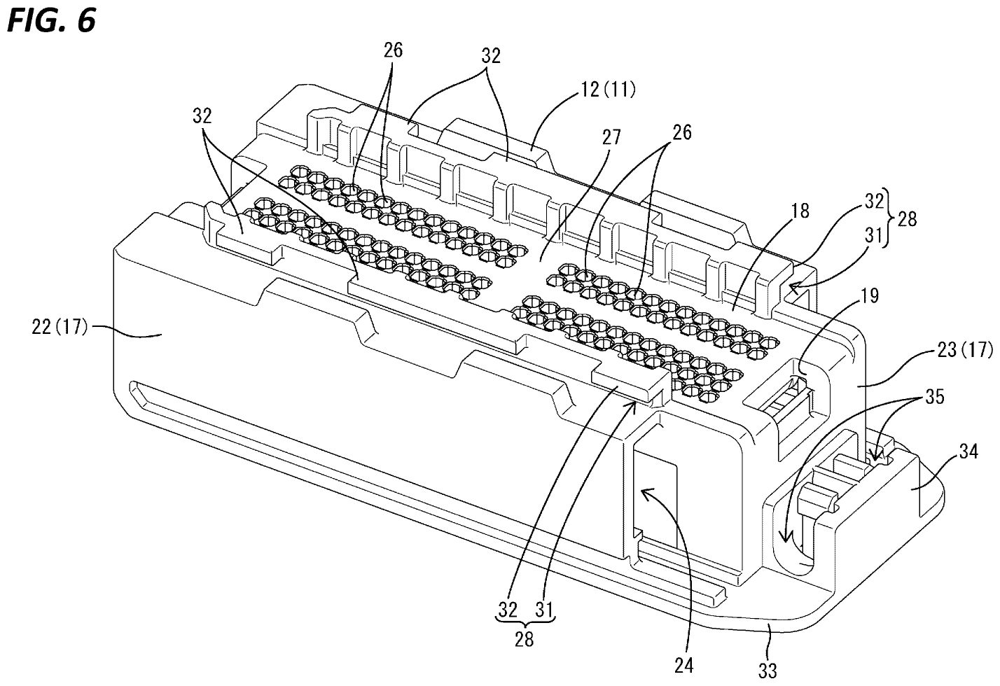

The outer housing 12 is shaped as a rectangular box that is long in the lateral direction. The outer housing 12 has a peripheral wall 17 that surrounds the outer periphery and a rear wall 18 that closes the rear end, and is open forward. The rear wall 18 restricts the batch rubber stopper 30 from coming out of the inner housing 13. The inner housing 13 is inserted from the front into the interior (the internal space defined by the peripheral wall 17 and the rear wall 18) of the outer housing 12 and contained therein. As shown in FIG. 6, locking holes 19 are formed in the peripheral wall 17 of the outer housing 12. As a result of locking protrusions 21 (see FIG. 1) that protrude in the lateral direction being fitted into the locking holes 19, the inner housing 13 is restricted from coming out of the outer housing 12.

A hood portion 101 of the mating housing 100 is fitted between the peripheral wall 17 of the outer housing 12 and the inner housing 13.

The peripheral wall 17 is composed of a pair of housing side surface portions 22 (see FIG. 4, only one housing side surface portion 22 is shown in FIG. 6) facing each other in the width direction and a pair of housing end surface portions 23 (only one housing end surface portion 23 is shown in FIGS. 4 and 6) facing each other in the lateral direction. As shown in FIG. 4, insertion holes 24 that are long in the front-rear direction are formed at both ends of each housing end surface portion 23 in the width direction. The sliders 40 are contained in the insertion holes 24.

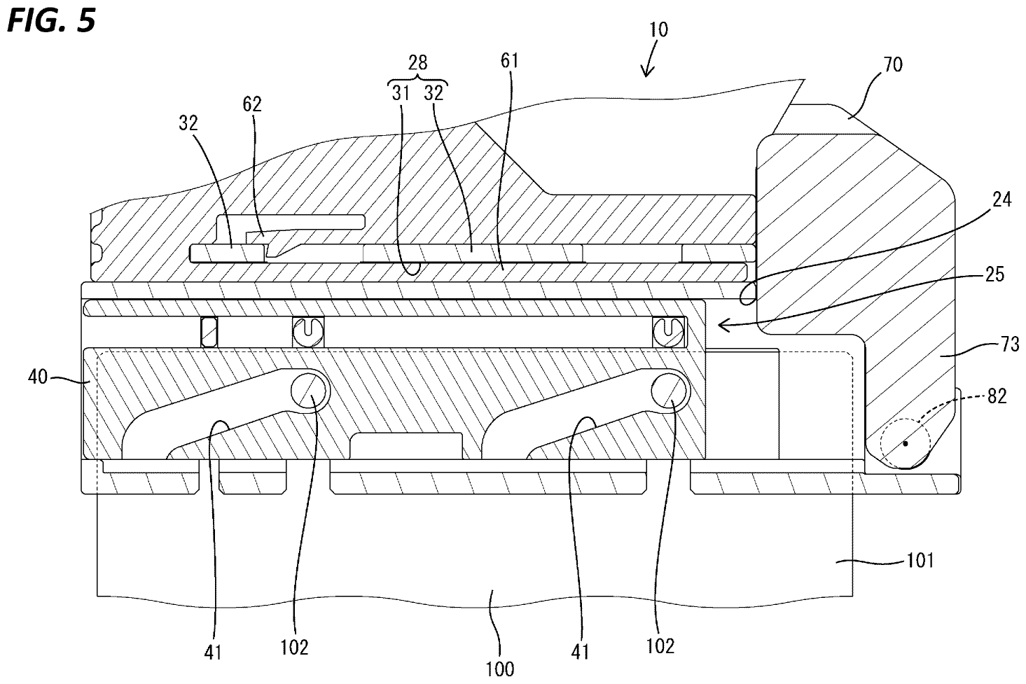

An insertion space 25 (see FIG. 5) communicating with the insertion holes 24 is formed inside the outer housing 12. The sliders 40 are inserted into the insertion space 25 from the insertion holes 24 on the one lateral side. The inner surface (the surface facing the insertion space 25) on the inner side in the width direction and the outer surface on the outer side in the width direction of each housing side surface portion 22 are flat in the lateral direction and the front-rear direction (see FIG. 4).

As shown in FIG. 6, a plurality of through holes 26 are formed in the rear wall 18. The electric wires W extending from the batch rubber stopper 30 pass through the through holes 26. The rear wall 18 has the drawing-out surface 27 from which the electric wires W are drawn out, on its rear surface facing rearward. The rear wall 18 has a slide portion 28 at the boundary between the outer periphery of the drawing-out surface 27 and each housing side surface portion 22. A pair of slide portions 28 are formed at both ends of the rear surface of the rear wall 18 in the width direction. Each slide portion 28 has a groove portion 31 extending in the lateral direction and a plurality of eave-shaped retaining portions 32 that partially close the groove portion 31. As shown in FIG. 5, the below-described guide portion 61 of the cover 50 is slidably inserted into the groove portion 31 of the slide portion 28. Each retaining portion 32 engages with the guide portion 61 to restrict the cover 50 from coming out of the outer housing 12.

As shown in FIGS. 1 and 6, the outer housing 12 has an extension portion 33 at its front end, which is shifted to the one lateral side relative to the peripheral wall 17. The outer housing 12 also has a support portion 34 that protrudes rearward from the extension portion 33. As shown in FIG. 6, the support portion 34 has a pair of bearing portions 35 arranged in the width direction. Each bearing portion 35 has a U-shaped cross section and is open rearward. The below-described rotation shaft 82 (see FIG. 3) of the lever 70 is rotatably inserted into each bearing portion 35.

### Slider 40

The sliders 40 are made of synthetic resin, and each have a plate shape long in the lateral direction as shown in FIG. 1. A pair of sliders 40 are attached to the housing 11 so as to correspond to the insertion holes 24 arranged in the width direction. The sliders 40 are each slidable in the lateral direction along the inner surface of the housing side surface portion 22 relative to the housing 11.

A plurality of cam grooves 41 are formed on the inner surface (facing surface) of each slider 40 apart from each other in the lateral direction. Each cam groove 41 extends in an oblique direction intersecting the lateral direction and is open at the front end of the slider 40. As shown in FIG. 5, a cam pin 102 formed on the hood portion 101 of the mating housing 100 is inserted into each cam groove 41. When the slider 40 moves, each cam pin 102 slides on the groove surface of the corresponding cam groove 41. This allows the housing 11 and the mating housing 100 to be fitted to each other or detached from each other.

As shown in FIG. 1, a pressure receiving portion 43 is recessed at one end of the inner surface of each slider 40 on the one lateral side. The pressure receiving portion 43 has a U-shaped cross section and is open rearward. As shown in FIGS. 2 and 3, in a state in which the slider 40 is attached to the housing 11, the pressure receiving portion 43 is shifted to the one lateral side relative to the housing side surface portion 22. The below-described pressing portion 81 of the lever 70 is inserted into the pressure receiving portion 43 so as to be capable of pressing in the lateral direction.

### Cover

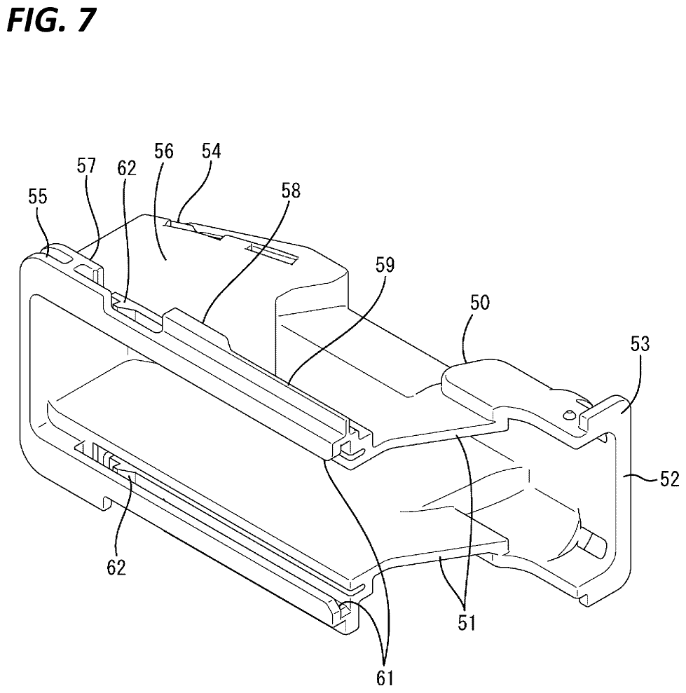

The cover 50 is made of synthetic resin, has a cap shape, and is open to the one lateral side and forward. As shown in FIG. 7, the cover 50 has a pair of cover side surface portions 51 arranged in the width direction and a back surface portion 52 connecting the rear ends of the cover side surface portions 51. The back surface portion 52 closes the rear end surface and the end surface on the other lateral side of the cover 50. Each electric wire W drawn out from the drawing-out surface 27 of the housing 11 is bent to the one lateral side by the back surface portion 52 inside the cover 50. The electric wire W is then led out from a lead-out end of the cover 50 on the one lateral side. The outer periphery of the lead-out end of the cover 50 is edged with a rib 53. An elastically deformable lock arm 54 is formed on the end surface of the back surface portion 52 on the other lateral side (see FIGS. 2 and 7), although its details are not shown.

In a state in which the cover 50 is attached to the housing 11, the cover side surface portions 51 and the housing side surface portions 22 are arranged side by side in the front-rear direction with the slide portions 28 as a boundary therebetween. The cover 50 has a wide portion 55 on the front end side close to the housing 11, a narrow portion 56 on the rear end side far from the housing 11, and a step portion 57 in the width direction between the narrow portion 56 and the wide portion 55. The wide portion 55, the narrow portion 56, and the step portion 57 are parts of the outer surface of each cover side surface portion 51 that form the maximum width of the cover 50 in the lateral direction. As shown in FIG. 4, the width dimension of the narrow portion 56 (see dl in FIG. 4) is smaller than the width dimension of the wide portion 55.

As shown in FIG. 2, the step portion 57 has a linear portion 58 extending in the lateral direction and a recess 59 adjacent to the linear portion 58 and recessed forward, when viewed from the outside in the width direction. The recess 59 has a bottom surface portion extending in the lateral direction.

As shown in FIG. 7, the cover 50 has a guide portion 61 extending in the lateral direction on the inner surface on the front end side of each cover side surface portion 51 opposite to the wide portion 55. As shown in FIG. 5, the guide portion 61 is slidably fitted into the groove portion 31 of the slide portion 28. The lever 70 has an elastically deformable cover lock portion 62 at a position facing the guide portion 61. As shown in FIG. 7, the cover lock portion 62 is exposed at the wide portion 55 and the step portion 57. As shown in FIG. 5, as a result of the cover lock portion 62 being locked to the retaining portion 32, the cover 50 is restricted from being displaced to the other lateral side (the left side in FIG. 5) relative to the outer housing 12. As a result of part of the wide portion 55 being locked to the retaining portion 32, the cover 50 is restricted from being displaced (to the right side in FIG. 5) relative to the outer housing 12.

### Lever

The lever 70 is made of synthetic resin and has a rectangular frame shape, and is supported rotatably between a start position (see FIG. 2) and a fitting position (see FIG. 3) relative to the housing 11. In the following description, the direction of the lever 70 is based on the state in which the lever 70 is at the fitting position relative to the housing 11.

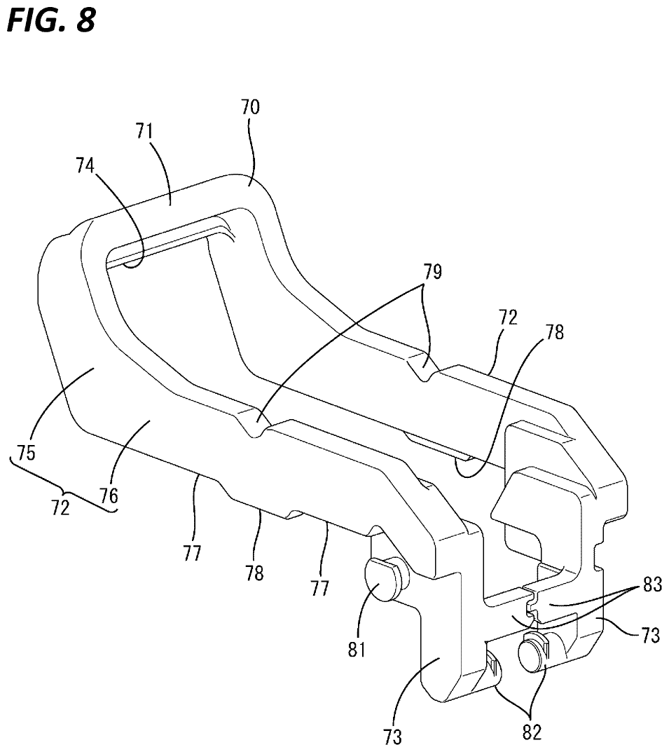

As shown in FIG. 8, the lever 70 has a connecting portion 71 extending in the width direction, a pair of side portions 72 extending from both ends of the connecting portion 71 in the width direction to the one lateral side, and a pair of base end portions 73 extending forward from the ends of the respective side portions 72 on the one lateral side. The part of connection between each side portion 72 and the corresponding base end portion 73 has an L-shaped intersection.

A lever lock portion 74 that is locked to the lock arm 54 is formed on the inner surface (forward facing surface) of the connecting portion 71.

The inner surface (the surface on the inner side in the width direction) of each side portion 72 is parallel to the lateral direction and the front-rear direction. The distance (spacing dimension) between the inner surfaces of the side portions 72 is set corresponding to the width dimension of the narrow portion 56.

Each side portion 72 has an inclined portion 75 inclined to the one lateral side from the connecting portion 71 in the front direction, and a main portion 76 extending from the inclined portion 75 to the base end portion 73 toward the one lateral side. The main portion 76 has, at its front end, a plurality of lateral portions 77 extending in the lateral direction and a projection 78 projecting forward at a lateral middle portion of the main portion 76 between the adjacent lateral portions 77. The projection 78 has a trapezoidal shape and has an end surface portion extending in the lateral direction. As shown in FIG. 3, the projection 78 is fitted into the recess 59 at the fitting position. The main portion 76 has, at its rear end, a triangular recessed groove 79 at a position corresponding to the projection 78. As shown in FIG. 2, the recessed groove 79 is locked to the rib 53 of the cover 50 at the start position. The projection 78 reinforces the lateral middle portion of the side portion 72 against weakening caused by the formation of the recessed groove 79.

As shown in FIG. 8, each base end portion 73 is connected to the corresponding main portion 76 in a state of being shifted inward in the width direction relative to the main portion 76. The outer surface (the surface on the outer side in the width direction) of each base end portion 73 is located inward in the width direction from the outer surface of the corresponding main portion 76. A pair of pressing portions 81 (only one pressing portion 81 is shown in FIG. 8) each protrude at the rear end of the outer surface of the corresponding base end portion 73. The tip end (the outer end in the width direction) of each pressing portion 81 in the protruding direction has a circular cam shape and presses the pressure receiving portion 43 of the corresponding slider 40, enabling the slider 40 to slide relative to the housing 11.

A pair of rotation shafts 82 each protrude at the front end of the inner surface (the surface on the inner side in the width direction) of the corresponding base end portion 73. The rotation shafts 82 are cylindrical and face each other. Each rotation shaft 82 is rotatably inserted into the corresponding bearing portion 35.

A pair of restricting portions 83 each protrude at the middle of the inner surface of the corresponding base end portion 73 in the front-rear direction. The restricting portions 83 are rectangular plate-shaped and face each other. The protruding tips of the restricting portions 83 are locked to each other through engagement of their recesses and projections. As a result of the restricting portions 83 being locked to each other, the side portions 72 are restricted from being misaligned in the front-rear direction.

### Functions of Connector

Prior to fitting of the housing 11 and the mating housing 100, the rotation shafts 82 are fitted and supported in the bearing portions 35, the pressing portions 81 are received in the pressure receiving portions 43, and the lever 70 is supported at the start position relative to the housing 11. As shown in FIG. 2, at the start position, the lever 70 is positioned relative to the cover 50 by fitting the end of each rib 53 into the corresponding recessed groove 79. Moreover, at the start position, the lever 70 is shifted to the one lateral side relative to the housing side surface portions 22 as a whole.

Subsequently, the mating housing 100 is shallowly fitted into the housing 11. As a result, each cam pin 102 of the mating housing 100 is inserted into the entrance of the corresponding cam groove 41 of the slider 40. In this state, the lever 70 is rotated about the rotation shafts 82 relative to the housing 11 toward the fitting position as indicated by the arrow in FIG. 2. The operator can smoothly rotate the lever 70 by pinching the connecting portion 71.

As the lever 70 moves toward the fitting position, the pressing portions 81 press the pressure receiving portions 43 and the sliders 40 slide toward the other lateral side relative to the housing 11. During this time, each cam pin 102 slides on the groove surface of the corresponding cam groove 41, and the fitting between the housing 11 and the mating housing 100 progresses.

When the lever 70 reaches the fitting position, the lever lock portion 74 is locked to the lock arm 54 of the cover 50, and the rotation of the lever 70 is stopped. Each cam pin 102 reaches the far end of the corresponding cam groove 41, and the housing 11 and the mating housing 100 are properly fitted together. Each terminal fitting 90 is electrically connected to a corresponding mating terminal (not shown) attached to the mating housing 100.

When the lever 70 reaches the fitting position, the front end of the main portion 76 of the side portion 72 rests on the step portion 57 of the cover 50 and the lateral portion 77 comes into contact with the linear portion 58, as shown in FIG. 3. Thus, the lever 70 is restricted from further rotation and is stopped at the fitting position. At the fitting position, the projections 78 of the lever 70 are fitted into the recesses 59 of the cover 50, and the lever 70 is restricted from being displaced relative to the cover 50.

Moreover, at the fitting position, the lever 70 except for the base end portions 73 is located along the outer surface of the cover 50. Specifically, the side portions 72 are located along the narrow portions 56 of the cover side surface portions 51, and the connecting portion 71 is located along the back surface portion 52. The base end portions 73 are each located on the one lateral side of the corresponding housing side surface portion 22, side by side with the housing side surface portion 22. Part of each base end portion 73 is located on the inner side of the corresponding slider 40 in the width direction. Meanwhile, the lever 70 does not have any part that overlaps (covers) each housing side surface portion 22 and is entirely apart from each housing side surface portion 22 rearward in the arrangement direction of the housing 11 and the cover 50, as shown in FIG. 3.

In the above case, it is assumed that the terminal fittings 90 are contained in all cavities 16 of the inner housing 13. In such specifications, the lever 70 is set to width dimension D1 and the cover 50 is set to width dimension d1, as shown in FIG. 4.

In the case of specifications in which the terminal fittings 90 are contained in only some of the cavities 16 of the inner housing 13, on the other hand, the number of electric wires W disposed inside the cover 50 is smaller than in the above case. Here, if the width dimensions of the cover 50 and lever 70 can be reduced, then the connector 10 can be reduced in size, which is preferable.

In this respect, in Embodiment 1, the lever 70 is entirely located apart from each housing side surface portion 22 rearward, so that the width dimension of the lever 70 can be determined independently of the distance between the outer surfaces of the housing side surface portions 22 in the width direction, i.e. the width dimension of the housing 11. In other words, the width dimension of the lever 70 can be determined simply by matching the distance between the inner surfaces of the side portions 72 to the distance between the outer surfaces of the cover side surface portions 51 in the width direction (the width dimension of the narrow portion 56).

Therefore, in a low pole state, it is possible to reduce the width dimension d2 of the cover 50 and reduce the width dimension D2 of the lever 70 by the reduction in the width dimension d2 of the cover 50 without changing the width dimension of the housing 11, as shown in FIG. 9. The resultant width dimension D2 of the lever 70 is smaller than the width dimension D1 (see FIG. 4), and the resultant width dimension d2 of the cover 50 is smaller than the width dimension d1. Hence, the connector 10 can be reduced in size on the rear side having the lever 70 and the cover 50.

As described above, according to Embodiment 1, the width dimension of the lever 70 can be set without being restricted by the housing side surface portions 22. Therefore, in the case where the number of electric wires W decreases, the width dimension of the cover 50 can be reduced and further the width dimension of the lever 70 can be reduced depending on the reduction in the width dimension of the cover 50 without changing the width dimension of the housing 11. The connector 10 can thus be reduced in size.

Moreover, in Embodiment 1, the lever 70 is shaped to extend long from the rotation shafts 82 to the connecting portion 71 so as not to overlap with the housing side surface portions 22. Therefore, the overall length of the lever 70 can be secured long, so that the lever 70 can be rotated with a small force.

Moreover, each side portion 72 has the main portion 76 extending from the rear end side of the base end portion 73 to the other lateral side, and when the lever 70 is at the fitting position, the main portion 76 faces the step portion 57 so as to be able to come into contact with it. Hence, the main portion 76 can prevent the cover 50 from being deformed on the step portion 57 side.

Moreover, the step portion 57 has the recess 59 recessed forward, the main portion 76 has the projection 78, and when the lever 70 is at the fitting position, the projection 78 is fitted into the recess 59. Displacement of the lever 70 relative to the housing 11 can thus be restricted.

### Other Embodiments of the Present Disclosure

The foregoing Embodiment 1 disclosed herein is illustrative and not restrictive in all respects.

In Embodiment 1, the lever is an operating lever for moving sliders having cam grooves. In another embodiment, the lever may have a boosting structure such as cam grooves to fit the housing and the mating housing together.

In Embodiment 1, the housing includes an inner housing and an outer housing. In another embodiment, the housing may have an inseparable integral structure. In another embodiment, a housing side surface portion may be formed on each outer surface of the housing in the width direction at such a position as to be arranged side by side with the cover side surface portion in the front-rear direction.

In Embodiment 1, the connector is a waterproof connector having a batch rubber stopper and a seal ring. In another embodiment, the connector may be a non-waterproof connector without a batch rubber stopper and a seal ring.

In Embodiment 1, the housing side surface portions and the cover side surface portions are plate-shaped parts of the housing and the cover, respectively. In another embodiment, the housing side surface portions and the cover side surface portions may be outer surface parts of the housing and the cover, respectively.

### LIST OF REFERENCE NUMERALS

10 Connector
11 Housing
12 Outer housing
13 Inner housing
14 Retainer
15 Front mask
16 Cavity
17 Peripheral wall
18 Rear wall
19 Locking hole
20 Seal ring
21 Locking protrusion
22 Housing side surface portion
23 Housing end surface portion
24 Insertion hole
25 Insertion space
26 Through hole
27 Drawing-out surface
28 Slide portion
30 Batch rubber stopper
31 Groove portion
32 Retaining portion
33 Extension portion
34 Support portion
35 Bearing portion
40 Slider
41 Cam groove
43 Pressure receiving portion
50 Cover
51 Cover side surface portion
52 Back surface portion
53 Rib
54 Lock arm
55 Wide portion
56 Narrow portion
57 Step portion
58 Linear portion
59 Recess
61 Guide portion
62 Cover lock portion
70 Lever
71 Connecting portion
72 Side portion
73 Base end portion
74 Lever lock portion
75 Inclined portion
76 Main portion
77 Lateral portion
78 Projection
79 Recessed groove
81 Pressing portion
82 Rotation shaft
83 Restricting portion
90 Terminal fitting
100 Mating housing
101 Hood portion
102 Cam pin
D1, D2 Width dimension of lever
d1, d2 Width dimension of cover
W Electric wire

1. A connector comprising:
a housing having a drawing-out surface for drawing out an electric wire;
a cover attached to the housing to cover the drawing-out surface; and
a lever rotatably supported by the housing,
wherein the lever includes a pair of side portions facing each other in a width direction, and a connecting portion connecting the pair of side portions,
the cover includes a pair of cover side surface portions located on an inner side of the pair of side portions in the width direction,
the housing includes a pair of housing side surface portions arranged side by side with the pair of cover side surface portions, at positions opposite to the pair of cover side surface portions with an outer periphery of the drawing-out surface as a boundary, and
the lever is apart from the pair of housing side surface portions in an arrangement direction in which the pair of cover side surface portions and the pair of housing side surface portions are arranged side by side.

2. The connector according to claim 1,
wherein the lever has a rotation shaft in a base end portion of each of the side portions, and
the housing has a bearing portion configured to receive the rotation shaft, at a position shifted to one side in a lateral direction relative to the housing side surface portions, the lateral direction intersecting the arrangement direction.

3. The connector according to claim 2,
wherein the base end portion has a shape extending in the arrangement direction across the cover and the housing, and each of the side portions includes a main portion extending from a position in the base end portion closer to the cover to another side in the lateral direction.

4. The connector according to claim 3,
wherein the pair of cover side surface portions each include a wide portion located on a side closer to the housing in the arrangement direction, a narrow portion narrower than the wide portion and located on a side farther from the housing in the arrangement direction, and a step portion located between the wide portion and the narrow portion, and
the main portion is located along the narrow portion.

5. The connector according to claim 4,
wherein when the housing and a mating housing are in a fitting state, the main portion faces the step portion to be able to be in contact with the step portion.

6. The connector according to claim 5,
wherein the step portion includes a recess that is recessed in the arrangement direction, and the main portion includes a projection that is fitted into the recess in the fitting state.
